(19) United States
(12) Patent Application Publication
(10) Pub. No.: US 2015/0130432 A1
(43) Pub. Date: May 14, 2015

(54) MATRIX CONVERTER AND METHOD FOR COMPENSATING FOR OUTPUT VOLTAGE ERROR

(71) Applicant: KABUSHIKI KAISHA YASKAWA DENKI, Kitakyushu-shi (JP)

(72) Inventors: Akira YAMAZAKI, Kitakyushu-shi (JP); Joji EBISU, Kitakyushu-shi (JP)

(73) Assignee: KABUSHIKI KAISHA YASKAWA DENKI, Kitakyushu-shi (JP)

(21) Appl. No.: 14/541,046

(22) Filed: Nov. 13, 2014

(30) Foreign Application Priority Data
Nov. 14, 2013 (JP) 2013-236070

(51) Int. Cl. H02M 5/293; H02M 1/088

(52) U.S. Cl. CPC H02M 5/293; H02M 1/088; H02M 2005/2932; H02M 2001/0003
USPC 323/272

(57) ABSTRACT

A matrix converter includes a power converter, a control information generator, a commutation controller, a storage, and an error compensator. The power converter includes bidirectional switches each having a conducting direction controllable by switching elements. The bidirectional switches are disposed between input terminals and output terminals. The input terminals are respectively coupled to phases of an AC power source. The output terminals are respectively coupled to phases of a load. The control information generator generates control information to control the bidirectional switches. The commutation controller controls each of the switching elements based on the control information so as to perform commutation control. The storage stores setting information of at least one of a method of the commutation control and a modulation method of power conversion. The error compensator compensates for an output voltage error based on the setting information.

### CROSS-REFERENCE TO RELATED APPLICATIONS

The present application claims priority under 35 U.S.C. §119 to Japanese Patent Application No. 2013-236070, filed Nov. 14, 2013. The contents of this application are incorporated herein by reference in their entirety.

### BACKGROUND

1. Field of the Invention

The present invention relates to a matrix converter and a method for compensating for an output voltage error.

2. Discussion of the Background

Matrix converters each include a plurality of bidirectional switches. The bidirectional switches couple the phases of an AC (Alternating Current) power supply to respective phases of a load. Each matrix converter controls the bidirectional switches to directly switch between the voltages for the phases of the AC power supply so as to output a desired voltage and a desired frequency to the load.

The bidirectional switches each include a plurality of switching elements. When the matrix converter uses the bidirectional switches to switch between the phases of the AC power supply to couple to the load, the matrix converter performs commutation control. In the commutation control, the matrix converter individually turns on or off each of the switching elements in a predetermined order. Although the commutation control prevents inter-line short-circuiting of the AC power supply and prevents opening of the output of the matrix converter, errors may occur in the output voltage.

In view of this, Japanese Unexamined Patent Application Publication Nos. 2004-7929 and 2007-82286 disclose correcting a voltage command based on the inter-line voltage of the AC power supply so as to compensate for output voltage error.

### SUMMARY

According to one aspect of the present disclosure, a matrix converter includes a power converter, a control information generator, a commutation controller, a storage, and an error compensator. The power converter includes a plurality of bidirectional switches each having a conducting direction controllable by a plurality of switching elements. The plurality of bidirectional switches are disposed between a plurality of input terminals and a plurality of output terminals. The plurality of input terminals are respectively coupled to phases of an AC power source. The plurality of output terminals are respectively coupled to phases of a load. The control information generator is configured to generate control information to control the plurality of bidirectional switches. The commutation controller is configured to control each of the plurality of switching elements based on the control information so as to perform commutation control. The storage is configured to store setting information of at least one of a method of the commutation control and a modulation method of power conversion. The error compensator is configured to compensate for an output voltage error based on the setting information.

According to another aspect of the present disclosure, matrix converter includes a power converter, a control information generator, a commutation controller, a storage, and an error compensator. The power converter includes a plurality of bidirectional switches each having a conducting direction controllable by a plurality of switching elements. The plurality of bidirectional switches are disposed between a plurality of input terminals and a plurality of output terminals. The plurality of input terminals are respectively coupled to phases of an AC power source. The plurality of output terminals are respectively coupled to phases of a load. The control information generator is configured to use a predetermined carrier wave to generate control information to control the plurality of bidirectional switches. The commutation controller is configured to control each of the plurality of switching elements based on the control information so as to perform commutation control. The storage is configured to store setting information of the carrier wave. The error compensator is configured to compensate for an output voltage error based on the setting information.

According to the other aspect of the present disclosure, a method for compensating for an output voltage error includes generating control information to control a plurality of bidirectional switches respectively coupled between phases of an AC power source and phases of a load. Each of a plurality of switching elements is controlled based on the control information so as to perform commutation control. The plurality of switching elements each have a controllable conducting direction and are included in the plurality of bidirectional switches. An output voltage error is compensated for based on setting information of at least one of a method of the commutation control and a modulation method of power conversion.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates an exemplary configuration of a matrix converter according to an embodiment;

FIG. 2 illustrates an exemplary configuration of a bidirectional switch illustrated in FIG. 1;

FIG. 3 illustrates a first exemplary configuration of a controller illustrated in FIG. 1;

FIG. 4 illustrates an on-off transition of a switching element in a 4-step current commutation method at Io>0;

FIG. 5 illustrates a relationship between a PWM control command, an output phase voltage, and a carrier wave in the 4-step current commutation method at Io>0;

FIG. 6 illustrates an on-off transition of the switching element in the 4-step current commutation method at Io<0;

FIG. 7 illustrates a relationship between a PWM control command, an output phase voltage, and a carrier wave in the 4-step current commutation method at Io<0;

FIG. 8 illustrates an on-off transition of the switching element in the 4-step voltage commutation method at Io>0;

FIG. 9 illustrates an on-off transition of the switching element in the 4-step voltage commutation method at Io<0;

FIG. 10 illustrates exemplary output voltage space vectors;

FIG. 11 illustrates an exemplary relationship between an output voltage command and space vectors;

FIG. 12 illustrates an exemplary switching pattern (pattern 1) at Ebase=Ep;

FIG. 13 illustrates an exemplary switching pattern (pattern 2) at Ebase=Ep;

FIG. 14 illustrates an exemplary switching pattern (pattern 1) at Ebase=En;

FIG. 15 illustrates an exemplary switching pattern (pattern 2) at Ebase=En;

FIG. 16 illustrates an exemplary relationship between a carrier wave and an output phase voltage in a three-phase modulation method;

FIG. 17 is a flowchart of an example of compensation amount calculation processing performed by a compensation amount calculator;

FIG. 18 illustrates an exemplary relationship between a carrier wave and a correction amount calculation cycle; and

FIG. 19 illustrates a second exemplary configuration of the controller illustrated in FIG. 1.

### DESCRIPTION OF THE EMBODIMENTS

A matrix converter according to an embodiment will be described in detail below by referring to the accompanying drawings. The following embodiment is provided for exemplary purposes only and is not intended in a limiting sense.

### [1. Configuration of Matrix Converter]

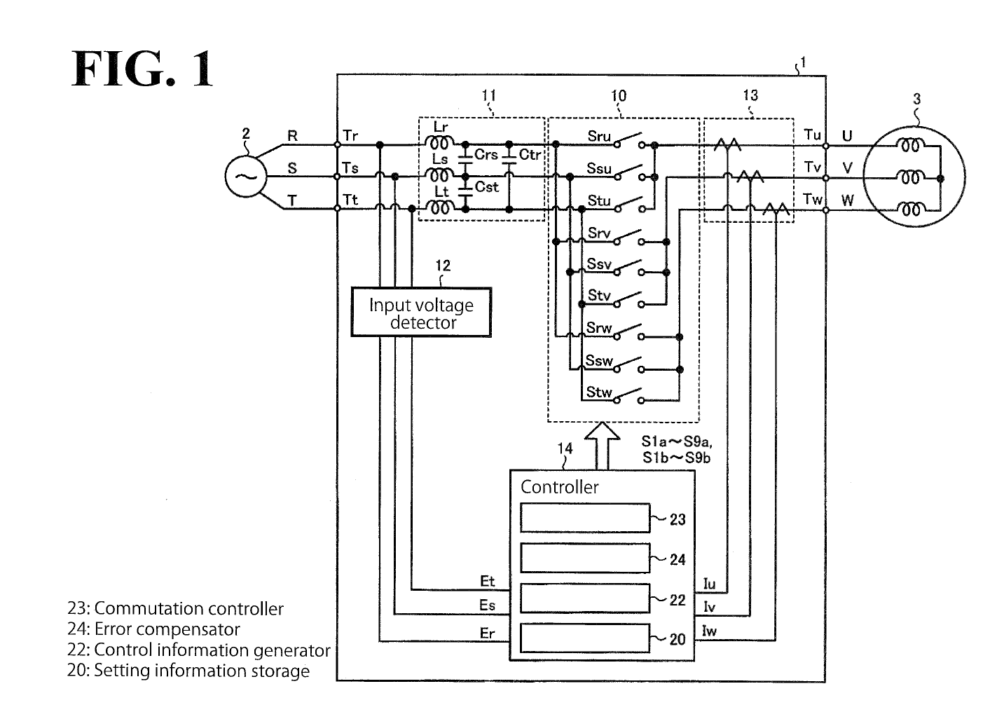

FIG. 1 illustrates an exemplary configuration of a matrix converter according to an embodiment. As illustrated in FIG. 1, the matrix converter 1 according to this embodiment is disposed between a three-phase AC power supply 2 (hereinafter simply referred to as an AC power supply 2) and a load 3. Examples of the load 3 include, but are not limited to, an AC motor and an electric generator. The AC power supply 2 includes an R phase, an S phase, and a T phase. The load 3 includes a U phase, a V phase, and a W phase. In the following description, the R phase, the S phase, and the T phase will be referred to as input phases, while the U phase, the V phase, and the W phase will be referred to as output phases.

The matrix converter 1 includes input terminals Tr, Ts, and Tt, output terminals Tu, Tv, and Tw, a power converter 10, an LC filter 11, an input voltage detector 12, an output current detector 13, and a controller 14. When the AC power supply 2 supplies three-phase AC power to the matrix converter 1 through the input terminals Tr, Ts, and Tt, the matrix converter 1 converts the three-phase AC power into three-phase AC power having a desired voltage and a desired frequency. The matrix converter 1 outputs the converted three-phase AC power to the load 3 through the output terminals Tu, Tv, and Tw.

The power converter 10 includes a plurality of bidirectional switches Sru, Ssu, Stu, Srv, Ssv, Stv, Srw, Ssw, and Stw (hereinafter occasionally collectively referred to as bidirectional switch Sw). The bidirectional switch Sw couples each phase of the AC power supply 2 to a corresponding to phase of the load 3.

The bidirectional switches Sru, Ssu, and Stu respectively couple the R phase, the S phase, and the T phase of the AC power supply 2 to the Uphase of the load 3. The bidirectional switches Srv, Ssv, and Sty respectively couple the R phase, the S phase, and the T phase of the AC power supply 2 to the V phase of the load 3. The bidirectional switches Srw, Ssw, and Stw respectively couple the R phase, the S phase, and the T phase of the AC power supply 2 to the W phase of the load 3.

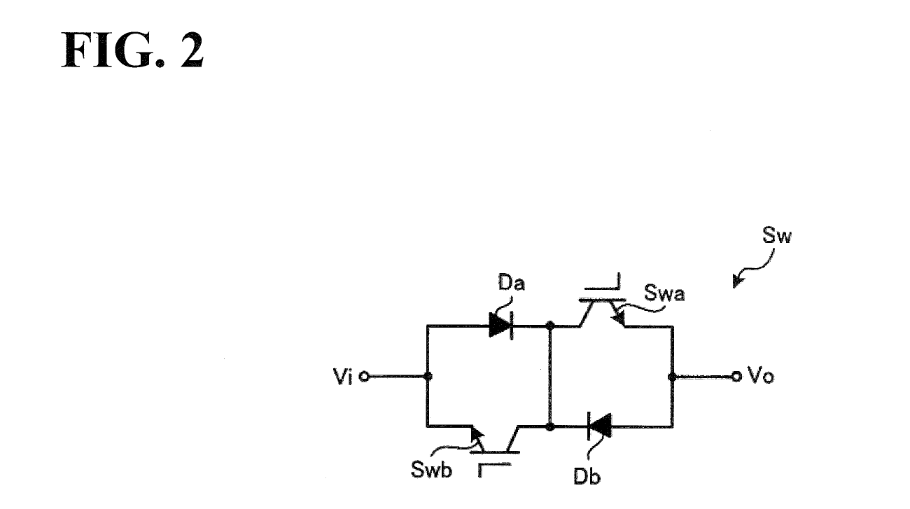

FIG. 2 illustrates an exemplary configuration of the bidirectional switch Sw. As illustrated in FIG. 2, the bidirectional switch Sw includes two series connection circuits. One series connection circuit includes a switching element Swa and a diode Da. The other series connection circuit includes a switching element Swb and a diode Db. These series connection circuits are anti-parallely coupled to each other. In FIG. 2, input phase voltage is denoted as Vi and output phase voltage is denoted as Vo.

It is noted that the bidirectional switch Sw will not be limited to the configuration illustrated in FIG. 2 insofar as the bidirectional switch Sw includes a plurality of switching elements to control the conduction direction. While in FIG. 2 the cathode of the diode Da and the cathode of the diode Db are coupled to each other, another possible example is that the cathode of the diode Da and the cathode of the diode Db are not coupled to each other.

Examples of the switching elements Swa and Swb include, but are not limited to, semiconductor switching elements such as metal-oxide-semiconductor field-effect transistor (MOSFET) and insulated gate bipolar transistor (IGBT). Other examples include next generation semiconductor switching elements such as SiC and GaN. When the switching elements Swa and Swb are reverse blocking IGBTs, no diode Da or Db are necessary.

Referring back to FIG. 1, the matrix converter 1 will be further described. The LC filter 11 is disposed between the R phase, the S phase, and the T phase of the AC power supply 2 and the power converter 10. The LC filter 11 includes three reactors Lr, Ls, and Lt, and three capacitors Crs, Cst, and Ctr to remove high-frequency components caused by switching of the bidirectional switch SW.

The input voltage detector 12 detects the phase voltage of each of the R phase, the S phase, and the T phase of the AC power supply 2. Specifically, the input voltage detector 12 detects instantaneous values Er, Es, and Et (hereinafter respectively referred to as input phase voltages Er, Es, and Et) of the phase voltages of the R phase, the S phase, and the T phase of the AC power supply 2.

The output current detector 13 detects the current between the power converter 10 and the load 3. Specifically, the output current detector 13 detects instantaneous values Iu, Iv, and Iw (hereinafter respectively referred to as output phase currents Iu, Iv, and Iw) of the current between the power converter 10 and the U phase, the V phase, and the W phase of the load 3. In the following description, the output phase currents Iu, Iv, and Iw may occasionally collectively be referred to as output phase current Io.

The controller 14 includes a setting information storage 20, a control information generator 22, a commutation controller 23, and an error compensator 24. The control information generator 22, the commutation controller 23, and the error compensator 24 acquire setting information stored in the setting information storage 20 to operate based on the acquired setting information.

The setting information storage 20 stores setting information such as modulation method parameters Pm, commutation method setting parameters Pt, and carrier frequency setting parameters Pf. An example of the setting information is input by a user or a person in charge of installation through an input device (not illustrated) of the matrix converter 1. Each modulation method parameter Pm represents a modulation method of the load 3. Each commutation method setting parameter Pt specifies a method of commutation control performed by the commutation controller 23. Each carrier frequency setting parameter Pf specifies, for example, the frequency of the carrier wave of the control information generator 22.

In order to control the bidirectional switch Sw, the control information generator 22 generates control information in accordance with the input phase voltages Er, Es, and Et, the output phase currents Iu, Iv, and Iw, the modulation method parameter Pm, and the carrier frequency setting parameter Pf. Specifically, the control information generator 22 generates the control information at intervals corresponding to the frequency of the carrier wave specified by the carrier frequency setting parameter Pf. When Pm=0, for example, the control information generator 22 generates control information in the two-modulation method, while when Pm=1, the control information generator 22 generates control information in the three-modulation method.

When the input phase voltages Er, Es, and Et are regarded as the input phase voltage Ep, Em, and En in descending order of magnitude, the two-phase modulation method is a method by which the input phase voltage at one output phase among the U phase, the V phase, and the Wphase is fixed to Ep or En, and the input phase voltages at the remaining two output phases are switched between Ep, Em, and En. Then, the input phase voltages at the remaining two output phases are output. The three-phase modulation method is a method by which the input phase voltages at all the output phases U phase, V phase, and W phase are switched between Ep, Em, and En. Thus, the modulation method varies depending on the number of output phases to which the power converter 10 outputs the voltage subjected to PWM modulation.

The commutation controller 23 generates drive signals S1a to S9a, and S1b to S9b (hereinafter occasionally collectively referred to as drive signal Sg) in accordance with the control information generated by the control information generator 22. The drive signals S1a to S9a, and S1b to S9b are for the purpose of performing commutation control in the commutation method corresponding to the commutation method setting parameter Pt.

The drive signals S1a to S9a are input into the gate of the switching element Swa, which is a part of each of the bidirectional switches Sm, Ssu, Stu, Srv, Ssv, Sty, Srw, Ssw, and Stw. The drive signals S1b to S9b are input into the gate of the switching element Swb, which is another part of each of the bidirectional switch Sm, Ssu, Stu, Srv, Ssv, Sty, Srw, Ssw, and Stw.

When Pt=0, for example, the commutation controller 23 selects the current commutation method to perform commutation control, while when Pt=1, the commutation controller 23 selects the voltage commutation method to perform commutation control. In switching the phases of the load 3 coupled to respective output phases at the bidirectional switch Sw, the commutation control individually turns on or off the switching elements Swa and Swb, which are the switching source and the switching destination of the bidirectional switches Sw. Thus, the commutation control prevents short-circuiting between the input phases and prevents opening of the output phases.

Based on the setting information stored in the setting information storage 20, the error compensator 24 calculates a compensation amount that corresponds to the setting information such as the commutation method, the modulation method, and the carrier wave. Then, the error compensator 24 performs error compensation of the output voltage based on the compensation amount.

In a first embodiment of the error compensation, based on the compensation amount corresponding to the setting information such as the commutation method, the modulation method, and the carrier wave, the error compensator 24 corrects the control information generated by the control information generator 22. Then, the error compensator 24 outputs the corrected control information to the commutation controller 23. In a second embodiment of the error compensation, the error compensator 24 corrects the output voltage command based on the compensation amount corresponding to the setting information such as the commutation method, the modulation method, and the carrier wave, and outputs the output voltage command to the control information generator 22.

Thus, the matrix converter 1 according to the embodiments calculates the compensation amount corresponding to the setting information, and compensates for output voltage error based on the compensation amount. Thus, the matrix converter 1 ensures accuracy in preventing the output voltage error even when the setting information of the type of the commutation method or the type of the modulation method is switched. The first embodiment of the error compensation will be described in detail by referring to a first exemplary configuration of the controller 14. Then, the second embodiment of the error compensation will be described in detail by referring to a second exemplary configuration of the controller 14. It is noted that the setting information may be one parameter or two parameters among the modulation method parameter Pm, the commutation method setting parameter Pt, and the carrier frequency setting parameter Pf.

### [2. First Exemplary Configuration of the Controller 14]

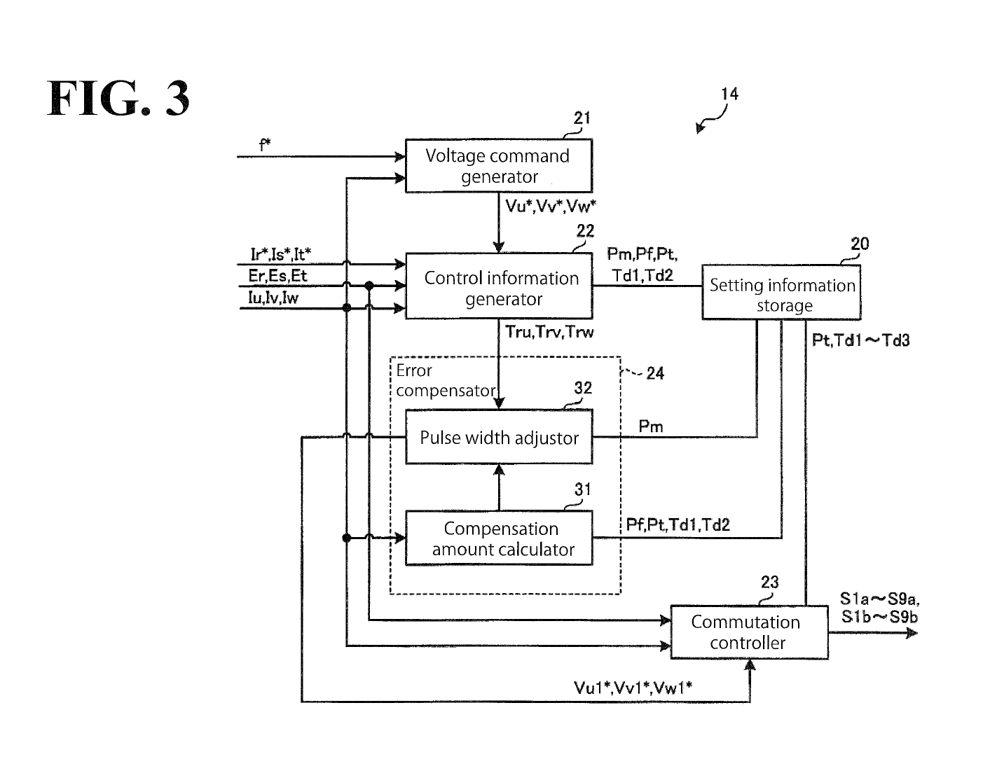

FIG. 3 illustrates a first exemplary configuration of the controller 14. As illustrated in FIG. 3, the controller 14 includes the setting information storage 20, the voltage command generator 21, the control information generator 22, the commutation controller 23, and the error compensator 24. The error compensator 24 includes a compensation amount calculator 31 and a pulse width adjustor 32.

The controller 14 includes a microcomputer and various circuits. The microcomputer includes a central processing unit (CPU), a read only memory (ROM), a random access memory (RAM), and an input-output port. The CPU of the microcomputer reads and executes a program stored in the ROM to function as the voltage command generator 21, the control information generator 22, the commutation controller 23, and the error compensator 24. When the CPU executes the program, the RAM performs a function as the setting information storage 20. It is possible to implement the controller 14 using hardware alone, without using any programs.

The setting information storage 20 stores, for example, a modulation method parameter Pm, a carrier frequency setting parameter Pf, commutation time parameters Td1 to Td3, and a commutation method setting parameter Pt. These pieces of information are input into the setting information storage 20 by a user or a person in charge of installation through, for example, the input device (not illustrated) of the matrix converter 1.

The voltage command generator 21 generates and outputs output voltage commands Vu*, Vv*, and Vw* of respective output phases (hereinafter occasionally referred to as output voltage command Vo*) at predetermined control intervals based on, for example, a frequency command f* and the output phase currents Iu, Iv, and Iw. The frequency command f* is a command indicating frequencies of the output phase voltages Vu, Vv, and Vw.

The control information generator 22 uses a space vector method in every half-cycle of the carrier wave Sc to calculate ratios of output vectors based on the input phase voltages Er, Es, and Et, the output phase currents Iu, Iv, and Iw, and the output voltage commands Vu*, Vv*, and Vw*. The ratios of output vectors each specify a pulse width for the PWM (Pulse Width Modulation) control. The control information generator 22 notifies the error compensator 24 of the calculated ratios of the output vectors as control information Tru, Trv, and Trw.

The output voltage command Vo* is used to calculate the control information Tru, Trv, and Trw. The control information generator 22 switches the output voltage command Vo* at the time corresponding to a top or valley of the carrier wave Sc. Assume that the cycle, Tsc, of the carrier wave Sc is twice the cycle of the output voltage command Vo*. In this case, the control information generator 22 switches the output voltage command Vo*, which is used to calculate the control information Tru, Trv, and Trw, in every two cycles of the carrier wave Sc at the time corresponding to the top or valley of the carrier wave Sc.

The error compensator 24 generates PWM control commands Vu1*, Vv1*, and Vw1* that have been subjected to output voltage error compensation in accordance with the control information Tru, Trv, and Trw, the setting information stored in the setting information storage 20, and the output phase currents Iu, Iv, and Iw.

The output voltage error compensation is processing to compensate for a deviation between the ratio of the output vector calculated by the control information generator 22 and the ratio of the output vector set in the commutation control by the commutation controller 23. The error compensator 24 outputs the generated PWM control commands Vu1*, Vv1*, and Vw1* (hereinafter occasionally referred to as PWM control command Vo1*) to the commutation controller 23. The PWM control command Vo1* includes information specifying the input phase voltage Vi (such information will be hereinafter referred to as specifying input phase information) to be output to the output phase.

When the specifying input phase information of the PWM control command Vo1* is changed, the commutation controller 23 performs commutation control to switch the phase of the AC power supply 2 coupled to the load 3 at the bidirectional switch Sw, and generates a drive signal Sg.

As described above, the error compensator 24 performs the output voltage error compensation in accordance with the type of the commutation method or the type of the modulation method of power conversion. The commutation method, the modulation method, and the error compensation will be described in detail below.

### [2.1. Commutation Control Method]

As described above, examples of the method of commutation performed by the commutation controller 23 include, but are not limited to, a current commutation method and a voltage commutation method. The commutation controller 23 selects the current commutation method or the voltage commutation method in accordance with the commutation method setting parameter Pt, which is stored in the setting information storage 20. By the selected commutation method, the commutation controller 23 performs the commutation control.

### [2.1.1. Current Commutation Method]

The current commutation method is a method of commutation performed on an individual output phase basis in accordance with a commutation pattern corresponding to the polarity of the output phase current Io. Here, a 4-step current commutation method will be described as an example of the current commutation method performed by the commutation controller 23.

In order to prevent short-circuiting between the input phases and prevent opening of the output phases, the commutation control using the 4-step current commutation method is based on a commutation pattern of the following steps 1 to 4 in accordance with the polarity of the output phase current Io.

Step 1: Turn OFF one switching element, among the switching elements of the bidirectional switch Sw serving as the switching source, that has a polarity opposite to the polarity of the output phase current Io in terms of the conduction direction.

Step 2: Turn ON one switching element, among the switching elements of the bidirectional switch Sw serving as the switching destination, that has the same polarity as the polarity of the output phase current Io in terms of the conduction direction.

Step 3: Turn OFF one switching element, among the switching elements of the bidirectional switch Sw serving as the switching source, that has the same polarity as the polarity of the output phase current Io in terms of the conduction direction.

Step 4: Turn OFF one switching element, among the switching elements of the bidirectional switch Sw serving as the switching destination, that has a polarity opposite to the polarity of the output phase current Io in terms of the conduction direction.

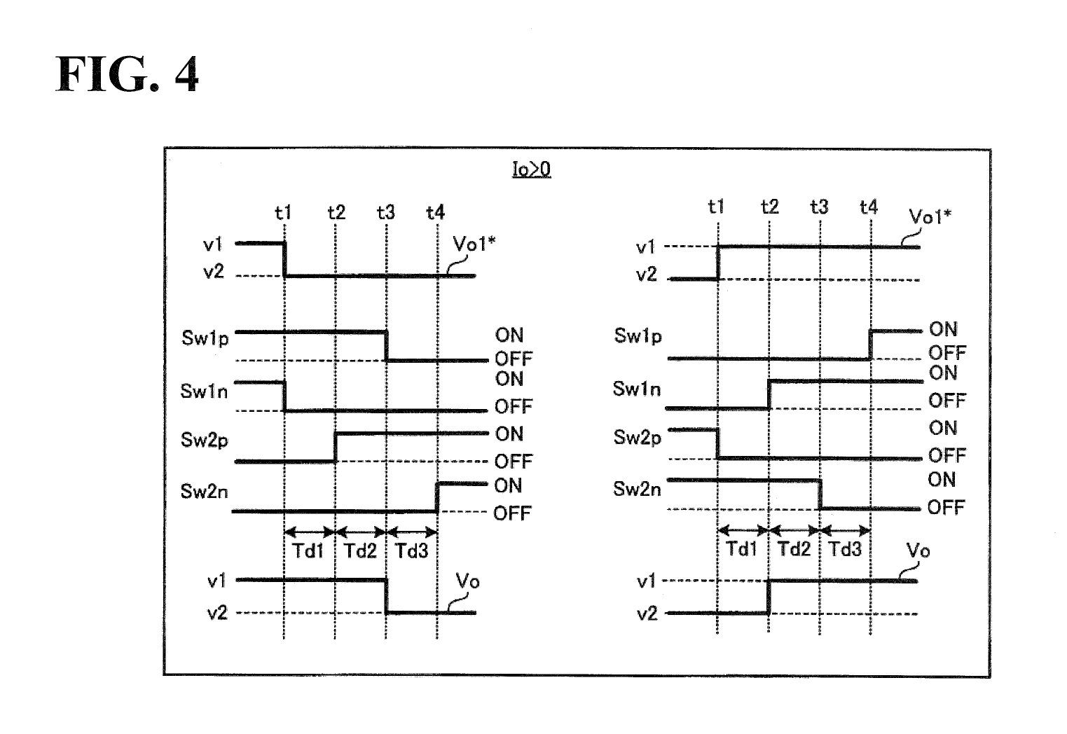

FIG. 4 illustrates an on-off transition of a switching element in the 4-step current commutation method at Io>0. Switching elements Sw1p and Sw1n respectively denote switching elements Swa and Swb of the bidirectional switch Sw serving as the switching source. Switching element Sw2p and Sw2n respectively denote switching elements Swa and Swb of the bidirectional switch Sw serving as the switching destination. Reference signs v1 and v2 each denote input phase voltage Vi and have the relationship v1>v2.

The PWM control command Vo1* specifies the input phase voltage Vi at Io>0. When the input phase voltage Vi is switched from v1 to v2, the output phase voltage Vo is switched at the timing when step 3 is performed (timing t3) as illustrated in FIG. 4. When the input phase voltage Vi at Io>0 is switched from v2 to v1 as specified in the PWM control command Vo1*, the output phase voltage Vo is switched at the timing when step 2 is performed (timing t2).

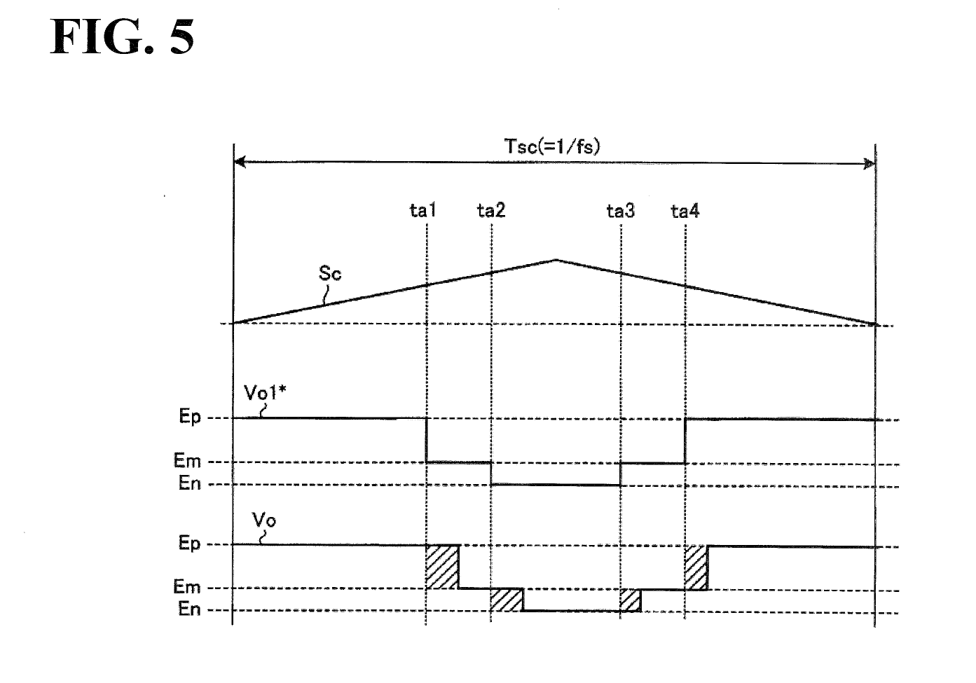

FIG. 5 illustrates a relationship between the PWM control command Vo1*, the output phase voltage Vo, and the carrier wave Sc in the 4-step current commutation method at Io>0. As illustrated in FIG. 5, the output phase voltage Vo is not switched at the timing when the input phase voltage Vi is switched as specified in the PWM control command Vo1*.

Specifically, the output phase voltage Vo is switched at the timings when step 3 is performed after timings ta1 and ta2, and at the timings when step 2 is performed after timings ta3 and timing ta4. Thus, an error of (Ep−En)×Td2/Tsc occurs in the output phase voltage Vo with respect to the PWM control command Vo1* in one cycle Tsc of the carrier wave Sc.

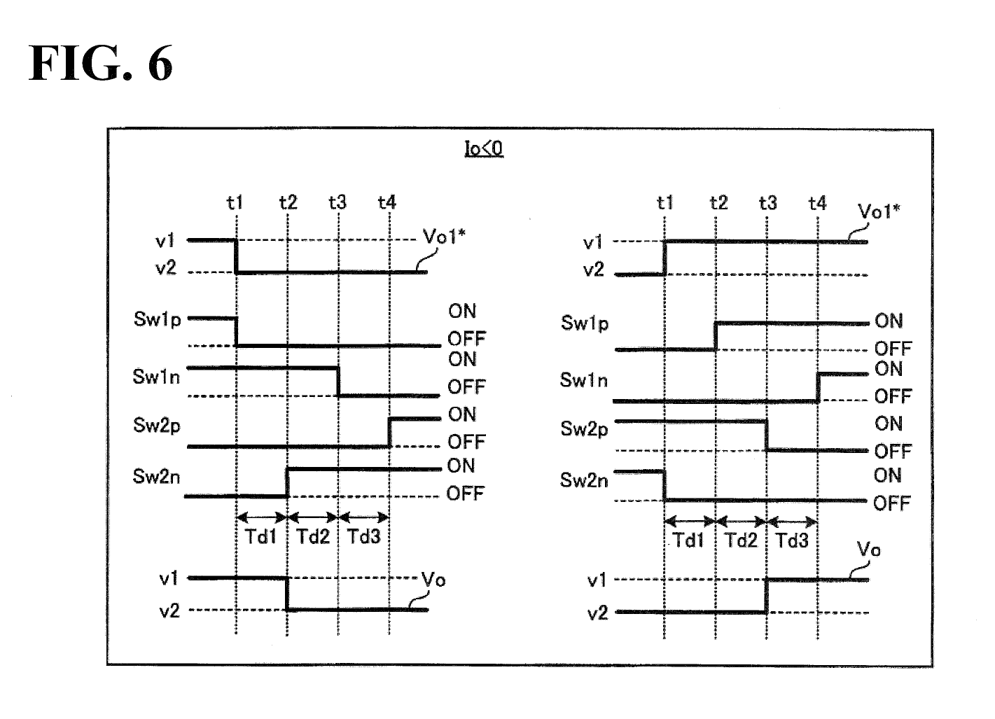

At Io<0, the timing when the input phase voltage Vi output to the output phase is switched is different from the timing at Io>0. FIG. 6 illustrates an on-off transition of the switching element in the 4-step current commutation method at Io<0.

When the input phase voltage Vi at Io<0 is switched from v1 to v2 as specified in the PWM control command Vo1*, the output phase voltage Vo is switched at the timing when step 2 is performed (timing t2) as illustrated in FIG. 6. When the input phase voltage Vi at Io<0 is switched from v2 to v1 as specified in the PWM control command Vo1*, the output phase voltage Vo is switched at the timing when step 3 is performed (timing t3).

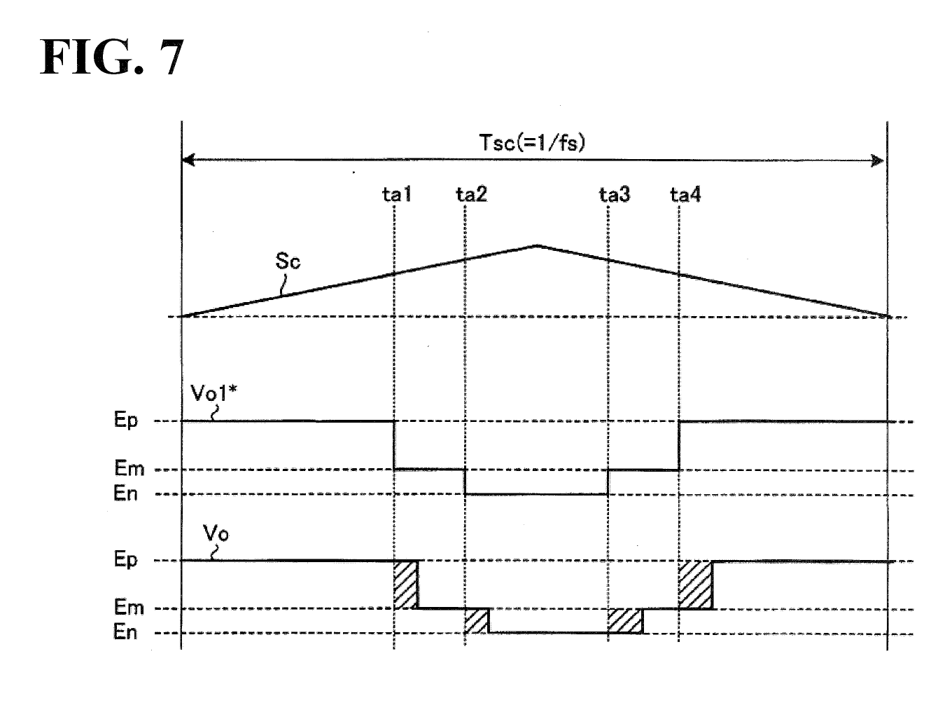

FIG. 7 illustrates a relationship between the PWM control command Vo1*, the output phase voltage Vo, and the carrier wave Sc in the 4-step current commutation method at Io<0. As illustrated in FIG. 7, the output phase voltage Vo is not switched at the timing when the input phase voltage Vi is switched as specified in the PWM control command Vo1*, similarly to the case at Io>0.

Specifically, the output phase voltage Vo is switched at the timings when step 2 is performed after timings ta1 and ta2, and at the timings when step 3 is performed after timings ta3 and timing ta4. Thus, an error of −(Ep−En)×Td2/Tsc occurs in the output phase voltage Vo with respect to the PWM control command Vo1* in one cycle Tsc of the carrier wave Sc.

Thus, in the commutation control using the current commutation method, the timing at which the output phase voltage Vo is changed varies depending on whether the voltage is increasing (v2 to v1) or decreasing (v1 to v2). This causes the output phase voltage Vo to have an error (hereinafter referred to as an output voltage error Voerr) with respect to the PWM control command Vo1*, and causes the polarity of the output voltage error Voerr to vary depending on the polarity of the output phase current Io.

### [2.1.2. Voltage Commutation Method]

The voltage commutation method is a method of commutation performed based on a commutation pattern that depends on a relationship of magnitude of the input phase voltages Er, Es, and Et. Here, a 4-step voltage commutation method will be described as an example of the voltage commutation method performed by the commutation controller 23.

In order to prevent short-circuiting between the input phases and prevent opening of the output phases, the commutation control using the 4-step voltage commutation method is based on a commutation pattern of the following steps 1 to 4 in accordance with a relationship of magnitude of the input phase voltages Er, Es, and Et. The commutation pattern in the 4-step voltage commutation method has no dependency on the polarity of the output phase current Io.

Step 1: Turn ON a reverse biased switching element in a switching destination.

Step 2: Turn OFF a reverse biased switching element in a switching source.

Step 3: Turn ON a forward biased switching element in the switching destination.

Step 4: Turn OFF a forward biased switching element in the switching source.

In the switching element Swa, the reverse bias refers to a state where the input side voltage is lower than the output side voltage immediately before the commutation control. The forward bias refers to a state where the input side voltage is higher than the output side voltage immediately before the commutation control. In the switching element Swb, the forward bias refers to a state where the input side voltage is lower than the output side voltage immediately before the commutation control. The reverse bias refers to a state where the input side voltage is higher than the output side voltage immediately before the commutation control.

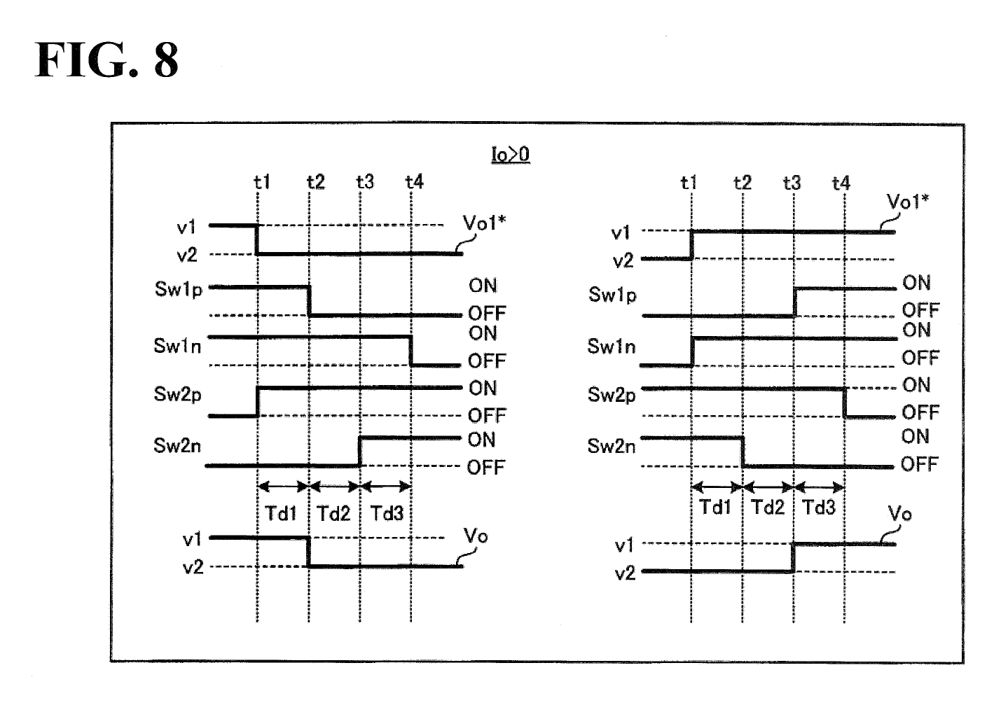

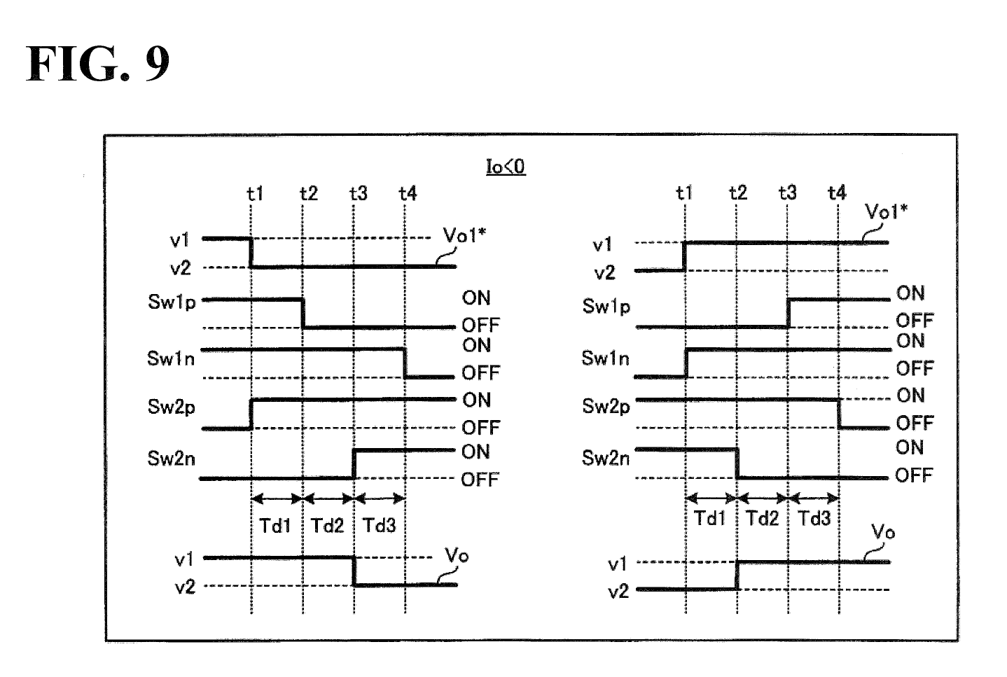

FIGS. 8 and 9 illustrate an on-off transition of the switching element in the 4-step voltage commutation method. The switching elements Sw1p, Sw1n, Sw2p, and Sw2n, and the voltages v1 and v2 are similar to those illustrated in FIGS. 4 and 6.

When the input phase voltage Vi at Io>0 is switched from v1 to v2 as specified in the PWM control command Vo1*, the output phase voltage Vo is switched at the timing when step 2 is performed (timing t2) as illustrated in FIG. 8. When the input phase voltage Vi at Io>0 is switched from v2 to v1 as specified in the PWM control command Vo1*, the output phase voltage Vo is switched at the timing when step 3 is performed (timing t3). Thus, the output voltage error Voerr in the case of the voltage commutation method at Io>0 is similar to the output voltage error Voerr in the case of the current commutation method at Io<0 (see FIG. 7). Namely, the output voltage error Voerr is −(Ep−En)×Td2/Tsc.

When the input phase voltage Vi at Io<0 is switched from v1 to v2 as specified in the PWM control command Vo1*, the output phase voltage Vo is switched at the timing when step 3 is performed (timing t3) as illustrated in FIG. 9. When the input phase voltage Vi at Io<0 is switched from v2 to v1 as specified in the PWM control command Vo1*, the output phase voltage Vo is switched at the timing when step 2 is performed (timing t2). Thus, the output voltage error Voerr in the case of the voltage commutation method at Io<0 is similar to the output voltage error Voerr in the case of the current commutation method at Io>0 (see FIG. 5). Namely, the output voltage error Voerr is (Ep−En)×Td2/Tsc.

Thus, the commutation control using the voltage commutation method is similar to the commutation control using the current commutation method in that the timing at which the output phase voltage Vo is changed varies depending on whether the voltage is increasing (v2 to v1) or decreasing (v1 to v2). This causes the output phase voltage Vo to have an output voltage error Voerr with respect to the PWM control command Vo1*, and causes the polarity of the output voltage error Voerr to vary depending on the polarity of the output phase current Io. In addition, the polarity of the output voltage error Voerr with respect to the polarity of the output phase current Io is different between the voltage commutation method and the current commutation method.

### [2.2. Method of Power Conversion Modulation]

Examples of the method of modulation performed by the control information generator 22 include, but are not limited to, a two-phase modulation method and a three-phase modulation method. The control information generator 22 selects one of the two-phase modulation method and the three-phase modulation method based on the modulation parameter Pm stored in the setting information storage 20, and generates the control information Tru, Trv, and Trw based on the selected method. For example, when Pm=0, the control information generator 22 selects the two-phase modulation method. When Pm=1, the control information generator 22 selects the three-phase modulation method.

By the modulation method corresponding to the modulation method parameter Pm, the control information generator 22 uses the space vector method to calculate the ratio of the output vector that specifies the pulse width of PWM control. The space vector method, the two-phase modulation method, and the three-phase modulation method will be described below in this order.

### [2.2.1. Space Vector Method]

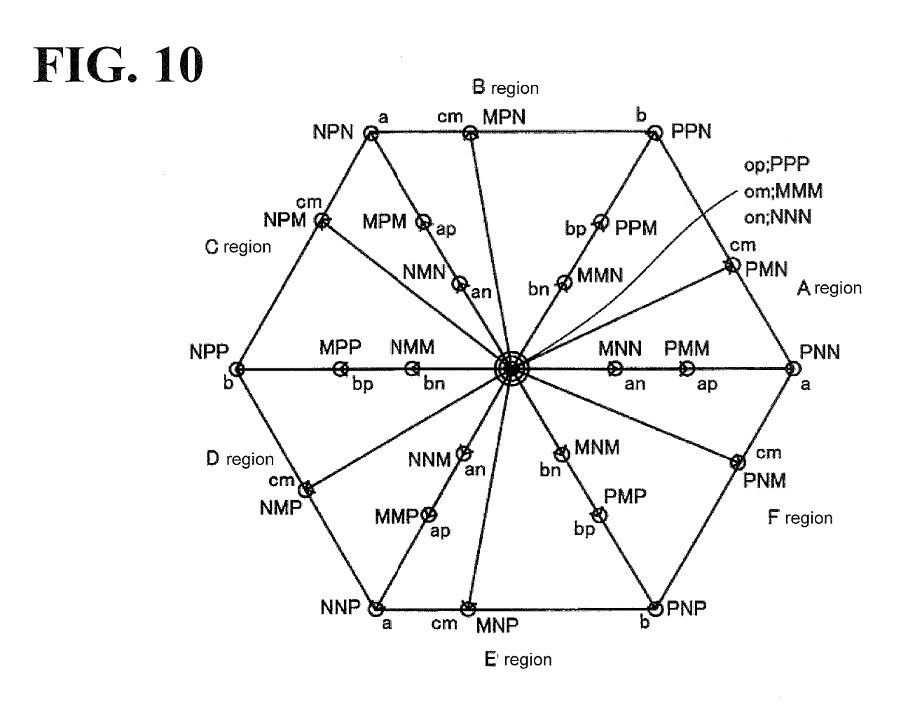

FIG. 10 illustrates exemplary output voltage space vectors. As illustrated in FIG. 10, each output voltage space vector is for the R phase, the S phase, and the T phase with a maximum voltage phase denoted as P, a minimal voltage phase denoted as N, and an intermediate voltage phase denoted as M.

In FIG. 10, the vector expression “a vector” denotes a state in which any one of the output phases U, V, and W is coupled to the maximum voltage phase P while the rest of the output phases U, V, and W are coupled to the minimal voltage phase N. The vector expression “b vector” denotes a state in which any one of the output phases is coupled to the minimal voltage phase N while the rest of the output phases are coupled to the maximum voltage phase P. For example, when the U phase is coupled to the maximum voltage phase P while the V phase and the W phase are coupled to the minimal voltage phase N, this state is denoted as PNN, which is a “a vector”. Similarly, NPN and NNP are “a vectors”. PPN, PNP, and NPP are “b vectors”.

The vector expressions “ap vector”, “an vector”, “bp vector”, and “bn vector” each denote a state in which one or some of the output phases is or are coupled to the intermediate voltage phase M. For example, the “ap vector” denotes a state in which any one of the output phases is coupled to the maximum voltage phase P while the rest of the output phases are coupled to the intermediate voltage phase M. The “an vector” denotes a state in which any one of the output phases is coupled to the intermediate voltage phase M while the rest of the output phases are coupled to the minimal voltage phase N. The “bp vector” denotes a state in which any two of the output phases are coupled to the maximum voltage phase P while the other one of the output phases is coupled to the intermediate voltage phase M. The “bn vector” denotes a state in which any two of the output phases are coupled to the intermediate voltage phase M while the other one of the output phases is coupled to the minimal voltage phase N. It is noted that a=ap+an, and b=bp+bn.

The vector expression “cm vector” denotes a state in which the U phase, the V phase, and the W phase are coupled to different input phases. The vector expressions “on vector”, “om vector”, and “op vector” denote a state in which all the U phase, V phase, and W phase are coupled to the same input phase. The vector expression “on vector” denotes a state in which all the output phases are coupled to the minimal voltage phase N. The vector expression “om vector” denotes a state in which all the output phases are coupled to the intermediate voltage phase M. The vector expression “op vector” denotes a state in which all the output phases are coupled to the maximum voltage phase P.

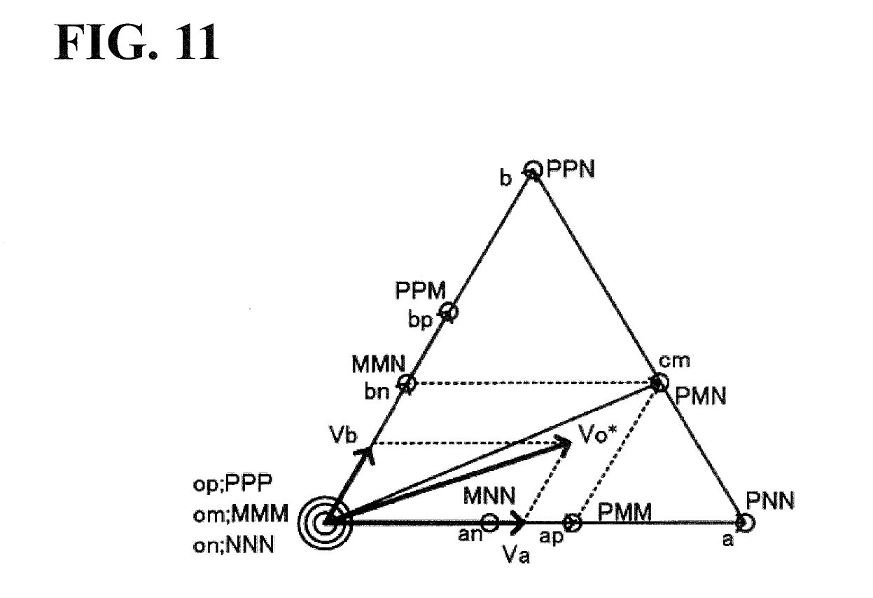

FIG. 11 illustrates an exemplary relationship between the output voltage command Vo* and the space vectors. As illustrated in FIG. 11, the control information generator 22 generates the control information Tru, Trv, and Trw based on a switching pattern that is a combination of a plurality of output vectors so as to output an “a vector component Va” and a “b vector component Vb” of the output voltage command Vo*. The combination is selected from among the “a vector”, the “ap vector”, the “an vector”, the “b vector”, the “bp vector”, the “bn vector”, the “cm vector”, the “op vector”, the “om vector”, and the “on vector”.

The control information generator 22 calculates the a vector component Va and the b vector component Vb based on following exemplary Formulae (1) and (2), where Vmax represents a maximum value, Vmid represents an intermediate value, and Vmin represents a minimal value among the output voltage commands Vu*, Vv*, and Vw*.

|Va|=Vmax−Vmid (1)

|Vb|=Vmid−Vmin (2)

The control information generator 22 regards as the base voltage Ebase an input phase voltage Vi with the greatest absolute value among the input phase voltages Er, Es, and Et. When the base voltage Ebase is Ep, the control information generator 22 calculates a current division ratio α based on the following exemplary Formula (3). When the base voltage Ebase is En, the control information generator 22 calculates the current division ratio α based on the following exemplary Formula (4). In Formulae (3) and (4), Ip, Im, and In are among the input current commands Ir*, Is*, and It*, and respectively represent current command values of phases corresponding to the input phase voltages Ep, Em, and En.

α=Im/In (3)

α=Im/Ip (4)

The input current commands Ir*, Is*, and It* are generated in an input power control section (not illustrated) of the controller 14 based on, for example, a positive phase voltage, an inverse phase voltage, and a set power factor command. The input current commands Ir*, Is*, and It* cancel out the influence of imbalance voltage and control the power factor of input current at a desired value.

The setting information storage 20 stores a modulation method parameter Pm. When the modulation method parameter Pm denotes the two-phase modulation, the control information generator 22 selects one switching pattern among four types of switching patterns illustrated in Table 1. Specifically, the control information generator 22 selects the switching pattern based on whether the base voltage Ebase is the input phase voltage Ep or En, and based on whether the phase state of the input phase voltage Vi satisfies |Vb|−α|Va|≧0. Based on the output voltage commands Vu*, Vv*, and Vw*, the control information generator 22 calculates a ratio of each of the output vectors constituting the selected switching pattern.

When, for example, the control information generator 22 has selected the switching pattern with pattern number “1”, the control information generator 22 calculates Top, Tbp, Tb, Tcm, and Ta in a carrier valley-to-top half-cycle of the carrier wave Sc. Top, Tbp, Tb, Tcm, and Ta respectively represent the ratio of the “op vector”, the ratio of the “bp vector”, the ratio of the “b vector”, the ratio of the “cm vector”, and the ratio of the “a vector”.

TABLE 1

| | Switching pattern | | |
|---|---|---|---|
| | Carrier half-cycle | Carrier half-cycle | Pattern |
| Condition | (valley → top) | (top → valley) | number |
| Ebase ≧ 0, | op → bp → | a → cm → | 1 |
| \|Vb\| − a\|Va\| ≧ 0 | b → cm → a | b → bp → op | |
| Ebase ≧ 0, | op → bp → | a → cm → | 2 |
| \|Vb\| − a\|Va\| < 0 | ap → cm → a | ap → bp → op | |
| Ebase < 0, | b → cm → | on → an → | 3 |
| \|Vb\| − a\|Va\| ≧ 0 | a → an → on | a → cm → b | |
| Ebase < 0, | a → cm → | on → an → | 4 |
| \|Vb\| − a\|Va\| < 0 | bn → an → on | bn → cm → a | |

When the modulation method parameter Pm denotes the three-phase modulation, the control information generator 22 selects the switching pattern illustrated in Table 2. Based on the output voltage commands Vu*, Vv*, and Vw*, the control information generator 22 calculates the ratio of each of the output vectors constituting the selected switching pattern.

TABLE 2
Switching pattern

| Carrier half-cycle | Carrier half-cycle |
|---|---|
| (valley → top) | (top → valley) |
| op → bp → ap → | on → an → bn → |
| om → bn → an → on | om → ap → bp → op |

The control information generator 22 generates control information Tru, Trv, and Trw. Each control information specifies the ratio of each of the output vectors constituting the selected switching pattern, and specifies pattern number. The control information generator 22 outputs the control information to the error compensator 24.

### [2.2.2. Two-Phase Modulation Method]

When the control information generator 22 has selected the two-phase modulation method, the control information generator 22 generates control information Tru, Trv, and Trw to fix the input phase voltage of one output phase among the U phase, the V phase, and the W phase is fixed to the base voltage Ebase and then output while switching the input phase voltages of the remaining two output phases between Ep, Em, and En. In the two-phase modulation method, the switching pattern varies depending on the base voltage Ebase and on the phase of the input phase voltage Vi, as described above.

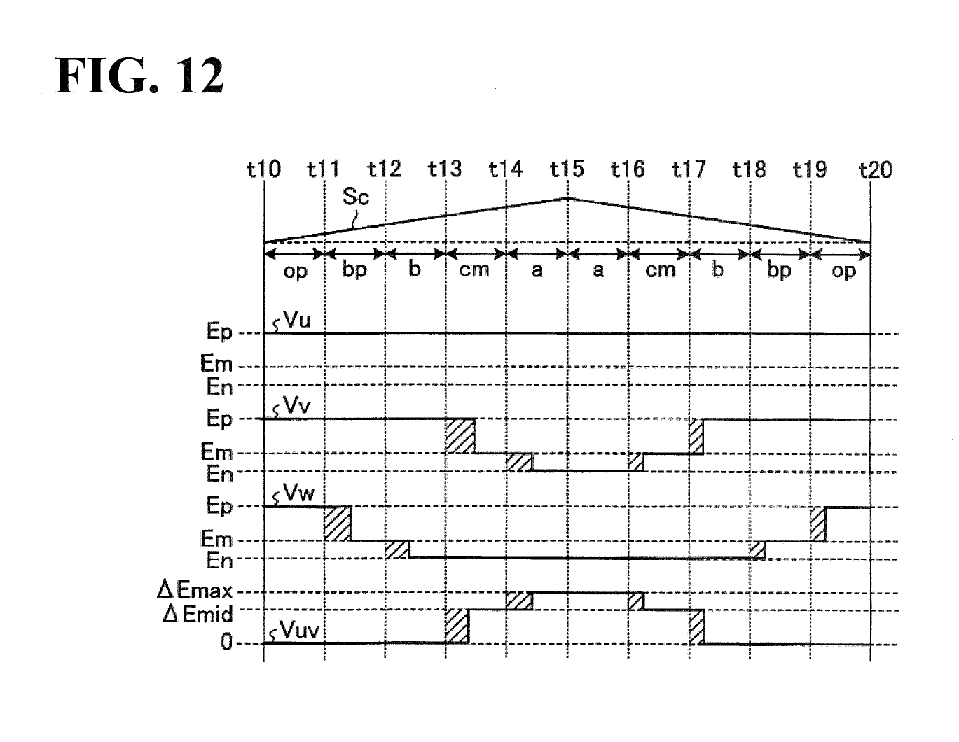

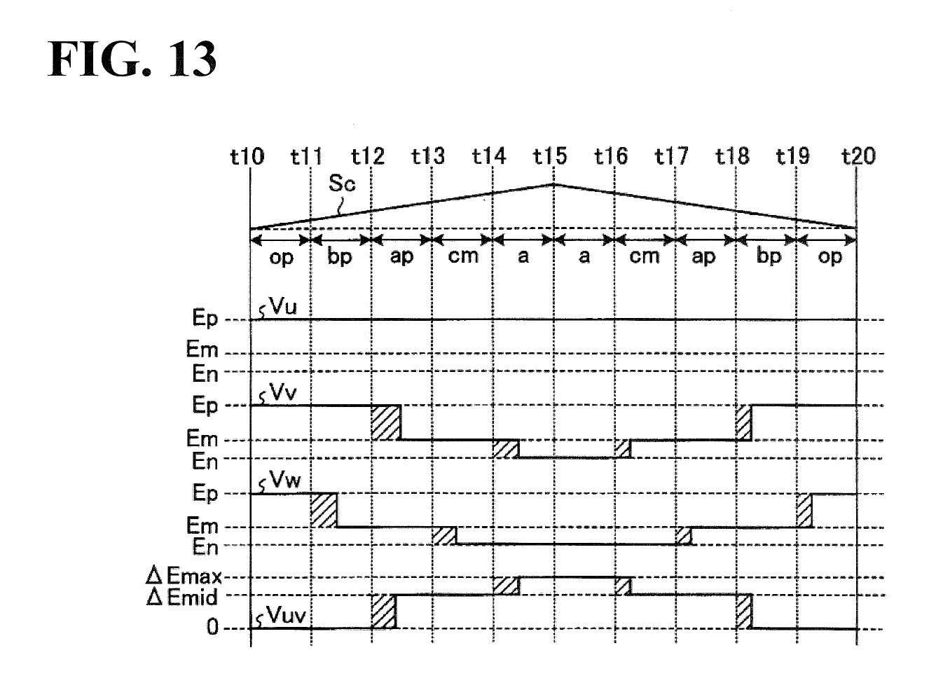

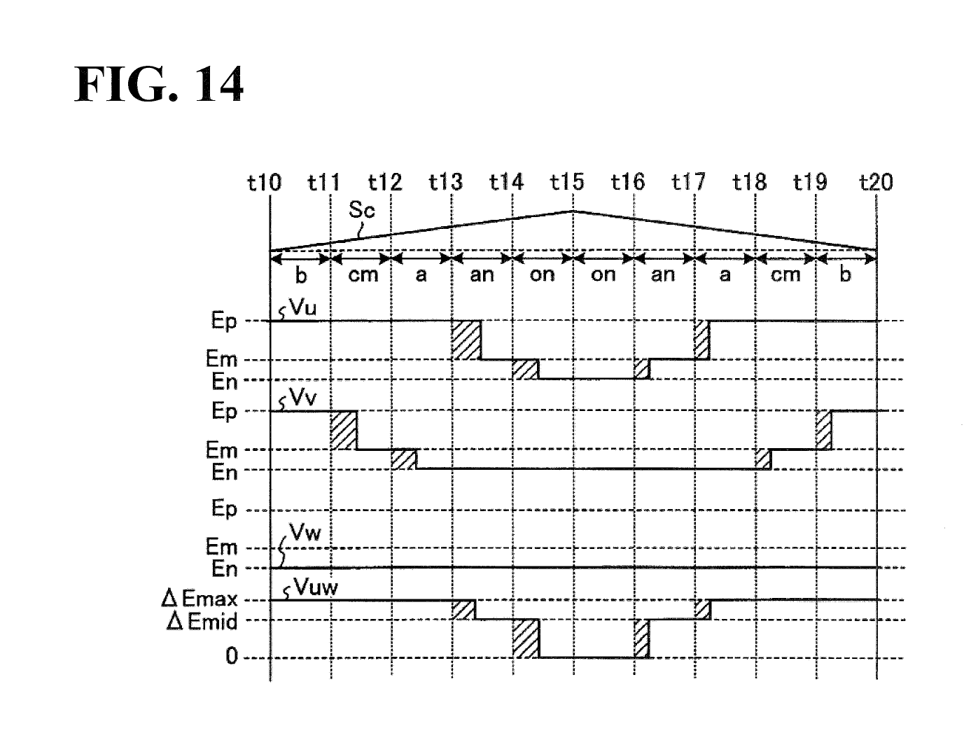

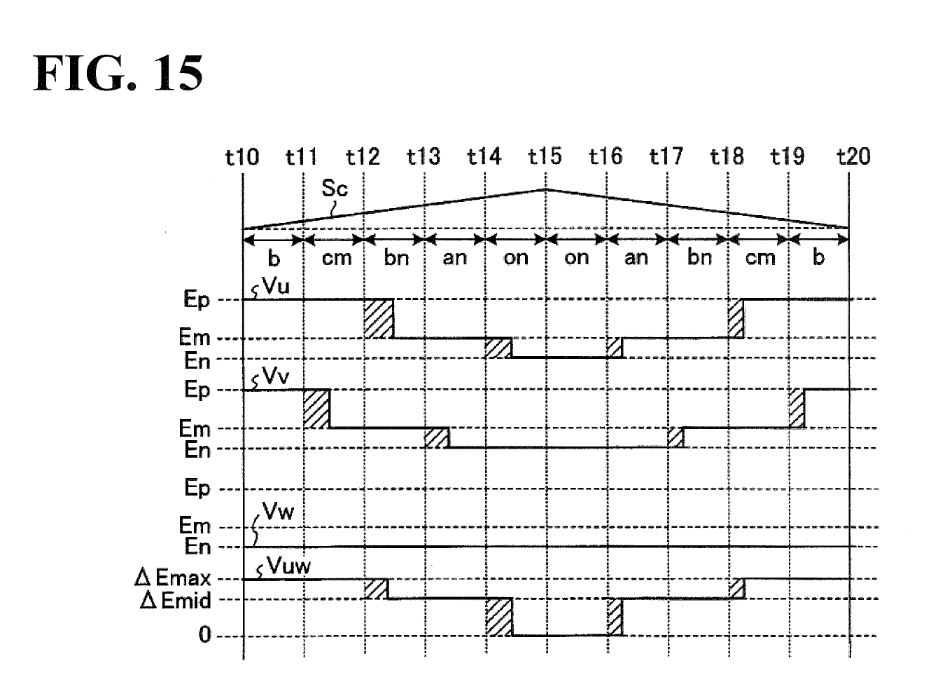

FIGS. 12 to 15 illustrate a relationship between the carrier wave Sc, the output phase voltages Vu, Vv, and Vw, and the base voltage Ebase in the two-phase modulation method in the relationship Vu>Vv>Vw. FIGS. 12 and 13 illustrate an exemplary switching pattern at Ebase=Ep. FIGS. 14 and 15 illustrate an exemplary switching pattern at Ebase=En.

FIGS. 12 and 14 each illustrate such a switching pattern that the input phase voltage Vi output to one output phase is continuously switched, and then the input phase voltage Vi output to another output phase is continuously switched. FIGS. 13 and 15 each illustrate such a switching pattern that the input phase voltage Vi output to one output phase and the input phase voltage Vi output to another output phase are alternately switched. Based on the input phase voltage Vi, the control information generator 22 switches between the switching patterns illustrated in FIGS. 12 and 14 and the switching patterns illustrated in FIGS. 13 and 15.

Thus, the two-phase modulation method includes four switching patterns that depend on the base voltage Ebase and the phase of the input phase voltage Vi.

### [2.2.3. Three-Phase Modulation Method]

The three-phase modulation method is a method by which the input phase voltages at all the output phases U phase, V phase, and W phase are switched between Ep, Em, and En. The three-phase modulation method has a single switching pattern.

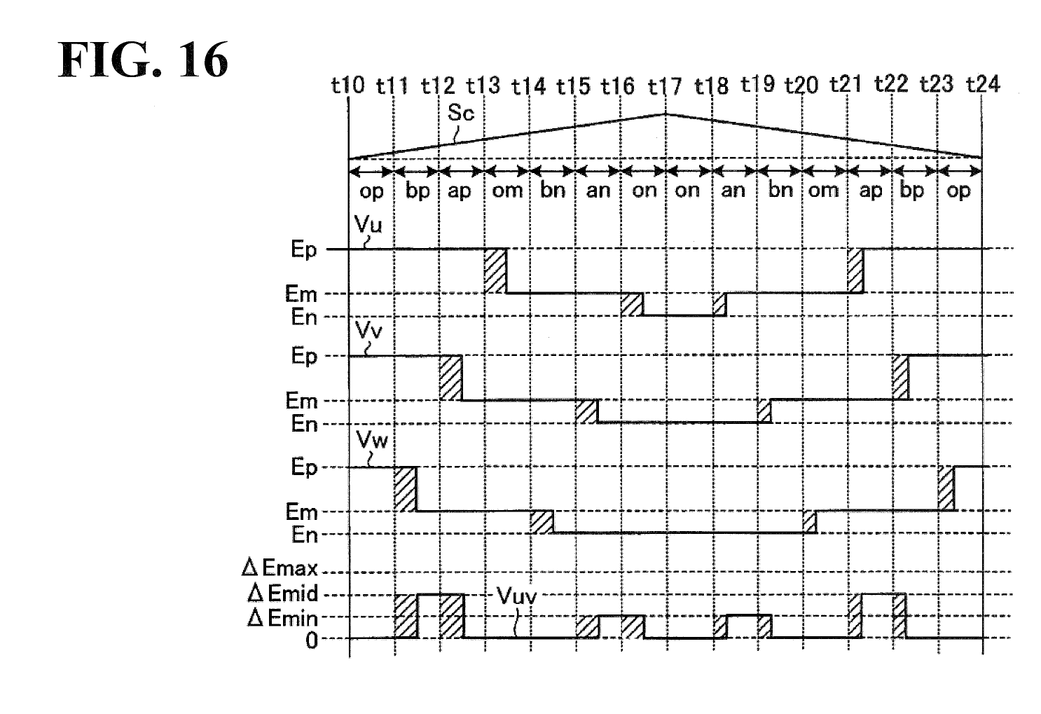

FIG. 16 illustrates an exemplary relationship between the carrier wave Sc and the output phase voltages Vu, Vv, and Vw in the three-phase modulation method in the relationship Vu>Vv>Vw. As illustrated in FIG. 16, in the three-phase modulation method, the power converter 10 outputs PWM pulse voltage to the U phase, the V phase, and the W phase. In the PWM pulse voltage, the input phase voltage Vi changes in the following manner Ep→Em→Em→En→En→Em→Em→Ep. FIG. 16 illustrates a state of commutation control using the current commutation method at Io>0.

### [2.3. Output Voltage Error Compensation]

As described above, the output voltage error correction is performed by the error compensator 24. As illustrated in FIG. 3, the error compensator 24 includes the compensation amount calculator 31 and the pulse width adjustor 32.

The compensation amount calculator 31 calculates the compensation amount to compensate for the output voltage error Voerr. Specifically, the compensation amount calculator 31 calculates compensation amounts Tcp(max), Tcp(mid), and Tcp(min) based on the type of the commutation method, the polarity of the output phase current Io, the commutation times Td1 and Td2, and the number of valleys and tops of the carrier wave Sc in a calculation cycle of the compensation amount Tc.

Tcp(max) is a compensation amount with respect to the maximum output voltage phase. Tcp(mid) is a compensation amount with respect to the intermediate output voltage phase. Tcp(min) is a compensation amount with respect to the minimal output voltage phase. The maximum output voltage phase is an output phase corresponding to the Vmax. The intermediate output voltage phase is an output phase corresponding to Vmid. The minimal output voltage phase is an output phase corresponding to Vmin. In the following description, Tcp(max), Tcp(mid), and Tcp(min) will be collectively referred to as Tcp(o). In the correction amount calculation cycle Tc, the number of tops of the carrier wave Sc will be referred to as Cy, the number of valleys of the carrier wave Sc will be referred to as Ct, and the number of the tops and the valleys of the carrier wave Sc will be referred to as Cyt.

The correction amount calculation cycle Tc is the same as the cycle at which the voltage command generator 21 calculates the output voltage command Vo*. Thus, the compensation amount Tcp(o) is calculated at each cycle of calculation of the output voltage command Vo^{*}. This improves the accuracy of the compensation amount Tcp(o). It is noted that the correction amount calculation cycle Tc may be 1/n (n is a natural number) of the cycle of calculation of the output voltage command Vo*.

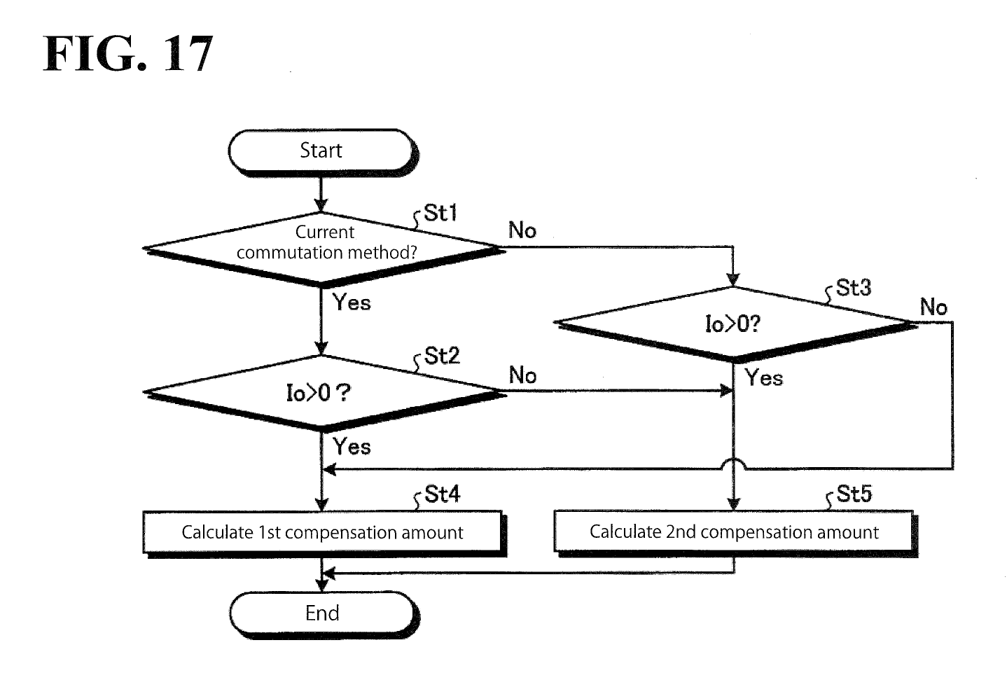

By referring to FIG. 17, detailed description will be made with regard to compensation amount calculation performed by the compensation amount calculator 31. FIG. 17 is a flowchart of an example of compensation amount calculation processing performed by the compensation amount calculator 31. The compensation amount calculation is performed for each of the output phases, namely, the U phase, the V phase, and the W phase.

As illustrated in FIG. 17, the compensation amount calculator 31 determines whether the commutation method is the current commutation method based on the commutation method setting parameter Pt stored in the setting information storage 20 (step St1).

When the compensation amount calculator 31 determines that the commutation method is the current commutation method (step St1; Yes), the compensation amount calculator 31 determines whether the polarity of the output phase current Io is positive (step St2). For example, in the compensation amount calculation processing for the U phase, the compensation amount calculator 43 determines whether the polarity of the output phase current Iu is positive.

When at step St1 the compensation amount calculator 31 determines that the commutation method is the voltage commutation method instead of the current commutation method (step St1; No), the compensation amount calculator 31 determines whether the polarity of the output phase current Io is positive (step St3), similarly to the processing at step St2.

When at step St2 the compensation amount calculator 31 determines that the polarity of the output phase current Io is positive (step St2; YES), or when the compensation amount calculator 31 determines that the polarity of the output phase current Io is not positive (step St3; No), the compensation amount calculator 31 performs first compensation amount calculation processing (step St4). At step St4, the compensation amount calculator 31 performs the first compensation amount calculation processing using, for example, the following Formula (5) to obtain the compensation amount Tcp(o).

$$Tcp ( o ) = \frac{( Td 1 + Td 2 ) \cdot Ct - Td 1 \cdot Cy}{Cyt} \qquad ( 5 )$$

When at step St2 the compensation amount calculator 31 determines that the polarity of the output phase current Io is not positive (step St2; No), or when the compensation amount calculator 31 determines that the polarity of the output phase current Io is positive (step St3; YES), the compensation amount calculator 31 performs second compensation amount calculation processing (step St5). At step St5, the compensation amount calculator 31 performs the second compensation amount calculation processing using, for example, the following Formula (6) to obtain the compensation amount Tcp(o).

$$Tcp ( o ) = \frac{Td 1 \cdot Ct - ( Td 1 + Td 2 ) \cdot Cy}{Cyt} \qquad ( 6 )$$

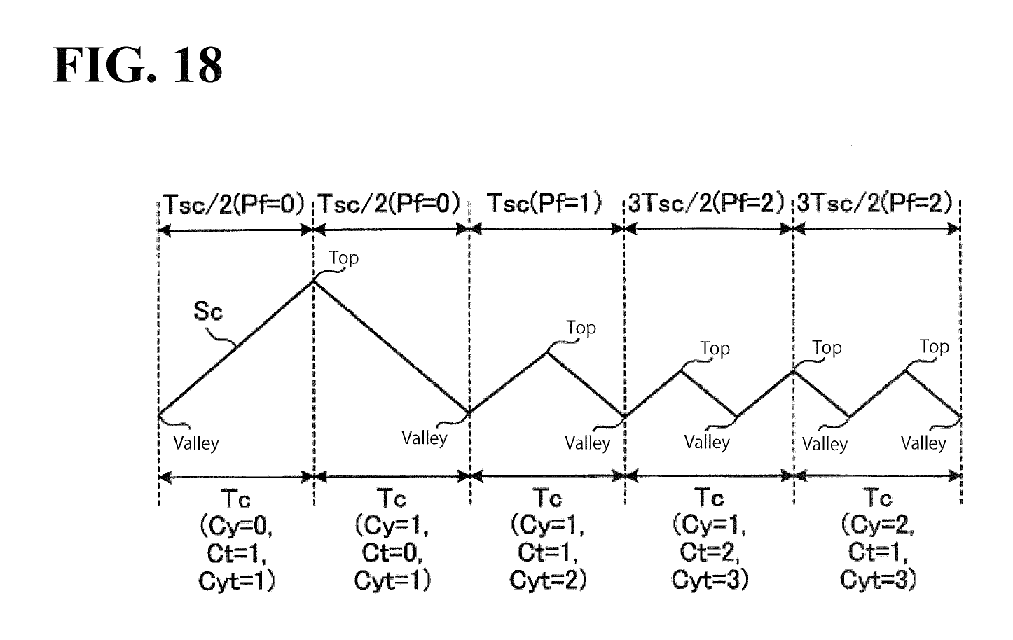

Thus, the compensation amount calculator 31 calculates the compensation amount Tcp(o) for each output phase based on the type of the commutation method, based on the output phase current Io, and based on the number of tops and valleys of the carrier wave Sc in the correction amount calculation cycle Tc. The compensation amount calculator 31 calculates Cy, Ct, and Cyt based on, for example, the carrier frequency setting parameter Pf. For example, when Pf=0 as illustrated in FIG. 18, then Tc=Tsc/2, Cy=0, Ct=1, and Cyt=1, or Tc=Tsc/2, Cy=1, Ct=0, and Cyt=1. When Pf=1, then Tc=Tsc, Cy=1, Ct=1, and Cyt=2. When Pf=2, then Tc=3Tsc/2, Cy=1, Ct=2, and Cyt=3, or Tc=3Tsc/2, Cy=2, Ct=1, and Cyt=3. FIG. 18 illustrates an exemplary relationship between the carrier wave Sc and the correction amount calculation cycle Tc.

Based on the switching pattern selected by the control information generator 22, the pulse width adjustor 32 corrects the control information Tru, Trv, and Trw output from the control information generator 22. As described later, “Tcp(o)×2fs” refers to a compensation amount that depends on the carrier wave Sc. “Tcp(o)×2fs” may be calculated by the compensation amount calculator 31 instead of the pulse width adjustor 32.

Specifically, when Pm=0 and the selected switching pattern has pattern number “1”, the pulse width adjustor 32 uses the following Formula (7) to calculate, for example, timings T1 to T5 respectively corresponding to times t11 to t15 illustrated in FIG. 12. Tcp(o)×2fs is a ratio of the compensation amount in a carrier half-cycle. The pulse width adjustor 32 calculates timings T1 to T5 based on fs corresponding to the carrier frequency setting parameter Pf and based on Tcp(o). As illustrated in FIG. 12, the minimal output voltage phase continuously changes and timings T1 and T2 are calculated based on Tcp(min). Then, the intermediate output voltage phase continuously changes and timings T3 and T4 are calculated based on Tcp(mid). With respect to the remaining carrier half-cycle, timings are similarly calculated using a compensation amount.

T1=Top−Tcp(min)·2fs

T2=Top+Tbp−Tcp(min)·2fs

T3=Top+Tbp+Tb−Tcp(mid)·2fs

T4=Top+Tbp+Tb+Tcm−Tcp(mid)·2fs

T5=Top+Tbp+Tb+Tcm+Ta (7)

When Pm=0 and the selected switching pattern has pattern number “2”, the pulse width adjustor 32 uses the following Formula (8) to calculate, for example, timings T1 to T5 respectively corresponding to times t11 to t15 illustrated in FIG. 13. As illustrated in FIG. 13, the minimal output voltage phase and the intermediate output voltage phase alternately change, and timings T1 and T3 are calculated based on Tcp(min), while timings T2 and T4 are calculated based on Tcp(mid). With respect to the remaining carrier half-cycle, timings are similarly calculated using a compensation amount.

T1=Top−Tcp(min)·2fs

T2=Top+Tbp−Tcp(mid)·2fs

T3=Top+Tbp+Tap−Tcp(min)·2fs

T4=Top+Tbp+Tap+Tcm−Tcp(mid)·2fs

T5=Top+Tbp+Tap+Tcm+Ta (8)

When Pm=0 and the selected switching pattern has the pattern number “3”, the pulse width adjustor 32 uses the following Formula (9) to calculate, for example, timings T1 to T5 respectively corresponding to times t11 to t15 illustrated in FIG. 14. As illustrated in FIG. 14, the intermediate output voltage phase continuously changes and timings T1 and T2 are calculated based on Tcp(mid). Then, the maximum output voltage phase continuously changes and timings T3 and T4 are calculated based on Tcp(max). With respect to the remaining carrier half-cycle, timings are similarly calculated using a compensation amount.

T1=Tb−Tcp(mid)·2fs

T2=Tb+Tcm−Tcp(mid)·2fs

T3=Tb+Tcm+Ta−Tcp(max)·2fs

T4=Tb+Tcm+Ta+Tan−Tcp(max)·2fs

T5=Tb+Tcm+Ta+Tan+Ton (9)

When Pm=0 and the selected switching pattern has pattern number “4”, the pulse width adjustor 32 uses the following Formula (10) to calculate, for example, timings T1 to T5 respectively corresponding to times t11 to t15 illustrated FIG. 15. As illustrated in FIG. 15, the intermediate output voltage phase and the maximum output voltage phase alternately change, and timings T1 and T3 are calculated based on Tcp(mid), while timings T2 and T4 are calculated based on Tcp(max). With respect to the remaining carrier half-cycle, timings are similarly calculated using a compensation amount.

T1=Tb−Tcp(mid)·2fs

T2=Tb+Tcm−Tcp(max)·2fs

T3=Tb+Tcm+Tbn−Tcp(mid)·2fs

T4=Tb+Tcm+Tbn+Tcm−Tcp(max)·2fs

T5=Tb+Tcm+Tbn+Tcm+Ton (10)

When Pm=1, the pulse width adjustor 32 uses the following Formula (11) to calculate timings T1 to T7 respectively corresponding to times t11 to t17 illustrated in FIG. 16. As illustrated in FIG. 16, the minimal output voltage phase, the intermediate output voltage phase, and the maximum output voltage phase sequentially change Thus, timings T1 and T4 are calculated based on Tcp(min). In addition, timings T2 and T5 are calculated based on Tcp(mid), and timings T3 and T6 are calculated based on Tcp(max). With respect to the remaining carrier half-cycle, timings are similarly calculated using a compensation amount.

T1=Top−Tcp(min)·2fs

T2=Top+Tbp−Tcp(mid)·2fs

T3=Top+Tbp+Tap−Tcp(max)·2fs

T4=Top+Tbp+Tap+Tom−Tcp(min)·2fs

T5=Top+Tbp+Tap+Tom+Tbn−Tcp(mid)·2fs

T6=Top+Tbp+Tap+Tom+Tbn+Tan−Tcp(max)·2fs

T7=Top+Tbp+Tap+Tom+Tbn+Tan+Ton (10)

Based on timings T1 to T5 (T1 to T7) calculated for each output phase, the pulse width adjustor 32 generates the PWM control commands Vu 1*, Vv 1*, and Vw 1*, which specify the input phase voltage Vi to be output to the output phases. The pulse width adjustor 32 outputs the generated PWM control command Vu1*, Vv1*, Vw1* to the commutation controller 23.

Thus, the error compensator 24 compensates for output voltage error based on the setting information stored in the setting information storage 20. Thus, the matrix converter 1 according to the embodiment ensures accuracy in preventing the output voltage error Voerr even when the type of the commutation method or the type of the modulation method is switched to another type. In addition, the matrix converter 1 according to the embodiment corrects the output voltage error Voerr based on the commutation time parameters Td1 and Td2, which are used for the commutation control. Thus, the matrix converter 1 according to the embodiment ensures accuracy in preventing the output voltage error Voerr.

### [3. Second Exemplary Configuration of the Controller 14]

Next, the second exemplary configuration of the controller 14 will be described. In the following description, the controller in the second exemplary configuration will be denoted at reference numeral 14A in order to distinguish it from the controller 14 in the first exemplary configuration.

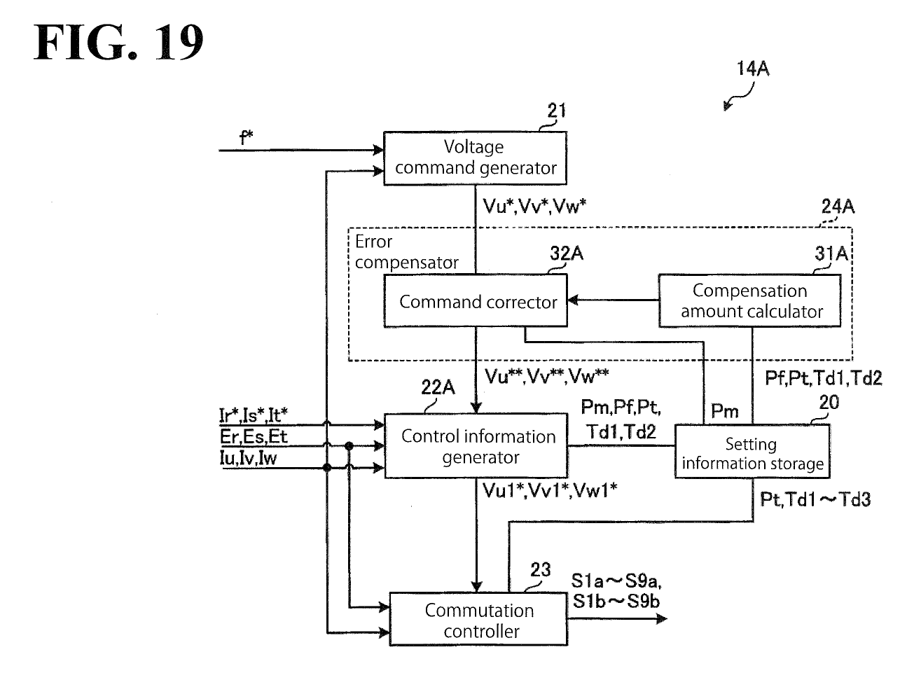

FIG. 19 is an exemplary configuration of the controller 14A. As illustrated in FIG. 19, the controller 14A includes the setting information storage 20, the voltage command generator 21, a control information generator 22A, the commutation controller 23, and an error compensator 24A. The setting information storage 20, the voltage command generator 21, and the commutation controller 23 of the controller 14A are respectively similar to the setting information storage 20, the voltage command generator 21, and the commutation controller 23 of the controller 14 in the first exemplary configuration, and thus will not be elaborated here.

Based on the corrected output voltage commands Vu*, Vv*, and Vw* corrected by the error compensator 24A, the control information generator 22A uses the space vector method to generate the PWM control commands Vu1*, Vv1*, and Vw1* (exemplary control information) to control the bidirectional switch Sw.

Specifically, the control information generator 22A uses a method similar to the method used for the control information generator 22 to calculate the ratios of the output vectors corresponding to the output voltage commands Vu*, Vv*, and Vw*, and generates the PWM control commands Vu1*, Vv1*, and Vw1* based on the ratios of the output vectors. The control information generator 22A calculates timings T1 to T5 (T1 to T7) for each output phase based on, for example, Formulae (8) to (11), less the subtraction portions of the compensation amounts Tcp(o)×2fs.

Based on the timings T1 to T5 (T1 to T7) calculated for each output phase, the control information generator 22A generates the PWM control commands Vu1*, Vv1*, and Vw1*, which specify the input phase voltage Vi to be output to the output phases. Then, the control information generator 22A outputs the generated PWM control commands Vu1*, Vv1*, and Vw1* to the commutation controller 23.

The error compensator 24A calculates a compensation amount to compensate for the output voltage error Voerr. The error compensator 24A includes a compensation amount calculator 31A and a command corrector 32A.

Similarly to the compensation amount calculator 31, the compensation amount calculator 31A calculates the compensation amount Tcp(o) based on the setting information stored in the setting information storage 20. Based on the setting information stored in the setting information storage 20, the compensation amount calculator 31A calculates the voltage command compensation amount Vcp(o) corresponding to the compensation amount Tcp(o). Specifically, the compensation amount calculator 31A calculates voltage command compensation amounts Vcp(max), Vcp(mid), and Vcp(min) respectively corresponding to the compensation amounts Tcp(max), Tcp(mid), and Tcp(min).

When Pm=0 and the selected switching pattern has the pattern number “1” or “2”, the compensation amount calculator 31A calculates the voltage command compensation amount Vcp(o) using, for example, the following Formula (12). It is noted that the maximum value among the output voltage commands Vu*, Vv*, and Vw* is referred to as Vmax, the intermediate value is referred to as Vmid, and the minimal value is referred to as Vmin.

$$Vcp ( min ) = \frac{V min \cdot Tcp ( min )}{Tsc / 2} \\ Vcp ( mid ) = \frac{V mid \cdot Tcp ( mid )}{Tsc / 2} \qquad ( 12 )$$

When Pm=0 and the selected switching pattern has the pattern number “3” or “4”, the compensation amount calculator 31A calculates the voltage command compensation amount Vcp(o) using, for example, the following Formula (13).

$$Vcp ( mid ) = \frac{V mid \cdot Tcp ( mid )}{Tsc / 2} \\ Vcp ( max ) = \frac{V max \cdot Tcp ( max )}{Tsc / 2} \qquad ( 13 )$$

When Pm=1, the compensation amount calculator 31A calculates the voltage command compensation amount Vcp(o) using, for example, the following Formula (14).

$$Vcp ( min ) = \frac{V min \cdot Tcp ( min )}{Tsc / 2} \\ Vcp ( mid ) = \frac{V mid \cdot Tcp ( mid )}{Tsc / 2} \\ Vcp ( max ) = \frac{V max \cdot Tcp ( max )}{Tsc / 2} \qquad ( 14 )$$

The command corrector 32A adds the voltage command compensation amount Vcp(o) to the output voltage command Vo* to correct the output voltage command Vo*. Then, the command corrector 32A outputs as the output voltage command Vo** the corrected output voltage command Vo* to the control information generator 22A.

Specifically, the command corrector 32A adds Vcp(max) to the output voltage command Vo* of the maximum value Vmax, adds Vcp(mid) to the output voltage command Vo* of the intermediate value Vmid, and adds Vcp(min) to the output voltage command of the minimal value Vmin. The command corrector 32A outputs as the output voltage command Vo** the corrected output voltage command Vo* to the control information generator 22A.

Thus, the error compensator 24A compensates for output voltage error based on the setting information stored in the setting information storage 20. Thus, the matrix converter 1 according to the embodiment ensures accuracy in preventing the output voltage error Voerr even when the type of the commutation method and the type of the modulation method are switched. In addition, the matrix converter 1 according to the embodiment corrects the output voltage error Voerr based on the time parameters Td1 and Td2, which are used for the commutation control. Thus, the matrix converter 1 according to the embodiment ensures accuracy in preventing the output voltage error Voerr.

In the above-described embodiments, the controllers 14 and 14A have been described as using the space vector method to generate the PWM control command Vo1*. It is also possible to use a triangular wave comparison method to generate the PWM control command Vo1*. This case is similar to the case of using the space vector method in that the error compensators 24 and 24A calculate the compensation amount Tcp(o) corresponding to the output voltage error Voerr caused by the commutation control, and compensate for the output voltage error Voerr based on the compensation amount Tcp(o). This ensures accuracy in eliminating or minimizing the output voltage error Voerr.

In generating the PWM control command Vo1*, the controllers 14 and 14A may also select between the space vector method and the triangular wave comparison method based on information input by a user or a person in charge of installation through the input device (not illustrated) of the matrix converter 1.

In the above-described embodiments, the controllers 14 and 14A have been described as selecting one commutation method from two commutation methods. It is also possible for the controllers 14 and 14A to select one commutation method from among equal to or more than three commutation methods based on the modulation method parameter Pm.

In the above-described embodiments, the control information Tru, Trv, and Trw, which are output from the control information generator 22, have been described as specifying the ratios of vectors. It is also possible for the control information generator 22 to generate such control information Tru, Trv, and Trw that specify timings of PWM control.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A matrix converter comprising:
a power converter comprising a plurality of bidirectional switches each having a conducting direction controllable by a plurality of switching elements, the plurality of bidirectional switches being disposed between a plurality of input terminals and a plurality of output terminals, the plurality of input terminals being respectively coupled to phases of an AC power source, the plurality of output terminals being respectively coupled to phases of a load;
a control information generator configured to generate control information to control the plurality of bidirectional switches;
a commutation controller configured to control each of the plurality of switching elements based on the control information so as to perform commutation control;
a storage configured to store setting information of at least one of a method of the commutation control and a modulation method of power conversion; and
an error compensator configured to compensate for an output voltage error based on the setting information.

2. A matrix converter comprising:
a power converter comprising a plurality of bidirectional switches each having a conducting direction controllable by a plurality of switching elements, the plurality of bidirectional switches being disposed between a plurality of input terminals and a plurality of output terminals, the plurality of input terminals being respectively coupled to phases of an AC power source, the plurality of output terminals being respectively coupled to phases of a load;
a control information generator configured to use a predetermined carrier wave to generate control information to control the plurality of bidirectional switches;
a commutation controller configured to control each of the plurality of switching elements based on the control information so as to perform commutation control;
a storage configured to store setting information of the carrier wave; and
an error compensator configured to compensate for an output voltage error based on the setting information.

3. The matrix converter according to claim 1, wherein the error compensator comprises
a compensation amount calculator to calculate a compensation amount in accordance with the setting information, and
a corrector configured to correct the control information based on the compensation amount calculated by the compensation amount calculator.

4. The matrix converter according to claim 1, further comprising a voltage command generator configured to generate an output voltage command,
wherein the error compensator comprises
a compensation amount calculator configured to calculate a compensation amount in accordance with the setting information, and
a corrector configured to correct the output voltage command based on the compensation amount calculated by the compensation amount calculator, and
wherein the control information generator is configured to generate the control information based on the output voltage command corrected by the error compensator.

5. The matrix converter according to claim 3, wherein the compensation amount calculator is configured to calculate the compensation amount based on a polarity of an output current obtained from the power converter.

6. The matrix converter according to claim 5,
wherein the modulation method comprises
two-phase modulation by which a voltage subjected to PWM modulation is output to two phases of the load, and
three-phase modulation by which a voltage subjected to PWM modulation is output to three phases of the load,
wherein when a type of the modulation method is the two-phase modulation, the corrector is configured to perform correction with respect to each of the two phases of the load based on the compensation amount, and
wherein when the type of the modulation method is the three-phase modulation, the corrector is configured to perform correction with respect to each of the three phases of the load based on the compensation amount.

7. The matrix converter according to claim 2, further comprising:
a compensation amount calculator configured to calculate a compensation amount based on a frequency of the carrier wave and based on a number of tops and valleys of the carrier wave in a calculation cycle of the compensation amount; and
a corrector configured to correct the control information based on the compensation amount calculated by the compensation amount calculator.

8. A method for compensating for an output voltage error, the method comprising:
generating control information to control a plurality of bidirectional switches respectively coupled between phases of an AC power source and phases of a load;
controlling each of a plurality of switching elements based on the control information so as to perform commutation control, the plurality of switching elements each having a controllable conducting direction and being included in the plurality of bidirectional switches; and
compensating for an output voltage error based on setting information of at least one of a method of the commutation control and a modulation method of power conversion.

9. The matrix converter according to claim 2, wherein the error compensator comprises
a compensation amount calculator to calculate a compensation amount in accordance with the setting information, and
a corrector configured to correct the control information based on the compensation amount calculated by the compensation amount calculator.

10. The matrix converter according to claim 2, further comprising a voltage command generator configured to generate an output voltage command,
wherein the error compensator comprises
a compensation amount calculator configured to calculate a compensation amount in accordance with the setting information, and
a corrector configured to correct the output voltage command based on the compensation amount calculated by the compensation amount calculator, and
wherein the control information generator is configured to generate the control information based on the output voltage command corrected by the error compensator.

11. The matrix converter according to claim 4, wherein the compensation amount calculator is configured to calculate the compensation amount based on a polarity of an output current obtained from the power converter.

12. The matrix converter according to claim 9, wherein the compensation amount calculator is configured to calculate the compensation amount based on a polarity of an output current obtained from the power converter.

13. The matrix converter according to claim 10, wherein the compensation amount calculator is configured to calculate the compensation amount based on a polarity of an output current obtained from the power converter.

14. The matrix converter according to claim 11,
wherein the modulation method comprises
two-phase modulation by which a voltage subjected to PWM modulation is output to two phases of the load, and
three-phase modulation by which a voltage subjected to PWM modulation is output to three phases of the load,
wherein when a type of the modulation method is the two-phase modulation, the corrector is configured to perform correction with respect to each of the two phases of the load based on the compensation amount, and
wherein when the type of the modulation method is the three-phase modulation, the corrector is configured to perform correction with respect to each of the three phases of the load based on the compensation amount.

15. The matrix converter according to claim 12,
wherein the modulation method comprises
two-phase modulation by which a voltage subjected to PWM modulation is output to two phases of the load, and
three-phase modulation by which a voltage subjected to PWM modulation is output to three phases of the load,
wherein when a type of the modulation method is the two-phase modulation, the corrector is configured to perform correction with respect to each of the two phases of the load based on the compensation amount, and
wherein when the type of the modulation method is the three-phase modulation, the corrector is configured to perform correction with respect to each of the three phases of the load based on the compensation amount.

16. The matrix converter according to claim 13,
wherein the modulation method comprises
two-phase modulation by which a voltage subjected to PWM modulation is output to two phases of the load, and
three-phase modulation by which a voltage subjected to PWM modulation is output to three phases of the load,
wherein when a type of the modulation method is the two-phase modulation, the corrector is configured to perform correction with respect to each of the two phases of the load based on the compensation amount, and
wherein when the type of the modulation method is the three-phase modulation, the corrector is configured to perform correction with respect to each of the three phases of the load based on the compensation amount.

17. A matrix converter comprising:
a power converter comprising a plurality of bidirectional switches each having a conducting direction controllable by a plurality of switching elements, the plurality of bidirectional switches being disposed between a plurality of input terminals and a plurality of output terminals, the plurality of input terminals being respectively coupled to phases of an AC power source, the plurality of output terminals being respectively coupled to phases of a load;
control information generating means for generating control information to control the plurality of bidirectional switches;
commutation controlling means for controlling each of the plurality of switching elements based on the control information so as to perform commutation control;
a storage configured to store setting information of at least one of a method of the commutation control and a modulation method of power conversion; and
error compensating means for compensating for an output voltage error based on the setting information.
